(19) United States
(12) Patent Application Publication
(10) Pub. No.: US 2014/0083287 A1
(43) Pub. Date: Mar. 27, 2014

(54) HYDRAULIC MOTOR CAPABLE OF MANY DIFFERENT APPLICATIONS ABLE TO USE LOW-PRESSURE OR HIGH-PRESSURE FLUIDS TO OPERATE

(71) Applicant: WELDY PEGUERO, Ridgefield Park, NJ (US)

(72) Inventor: WELDY PEGUERO, Ridgefield Park, NJ (US)

(21) Appl. No.: 13/626,950

(22) Filed: Sep. 26, 2012

(51) Int. Cl. F15B 21/00

(52) U.S. Cl. 91/218

(57) ABSTRACT

A hydraulic motor able to use low-pressure or high-pressure fluids such as water for a large number of applications. The motor uses a flow of water that is controlled and directed through a system of supply tubes to a chamber that fills with the fluid, moving a piston that produces an action such as rotating a shaft to turn a brush. Fluid fills the chamber through a system of opening and closing valves that direct and control the flow of the fluid so that the piston exerts pressure against a spring until it reaches a maximum position. A system of valves then reverses the flow of fluid until the piston is pushed in the opposite direction, producing an action such as turning a brush through the alternating application of water flows. A one-way gear box may be used to control the action of a shaft, which may be directed to turn in the same direction or in alternating directions to accomplish a wide variety of applications such as an hydraulic brush, gearbox speed increaser, generator or washing machine.

### FIELD OF THE INVENTION

The present invention relates to the field of fluid-powered hydraulic motors. More particularly, this invention relates to hydraulic motors operating on low-pressure or high-pressure water or other fluids and is useful for many different applications such as cleaning various objects and surfaces using water pressure to power a hydraulic brush using alternating flows of water.

### BACKGROUND OF THE INVENTION

The use of water pressure powered hydraulic motors is well known. These types of devices are found in such items as clothes washing machines, car washes, robot floor cleaners and toothbrushes. These all utilize turbines, wheels driven by water power which may use the power generated to move brushes.

Many types of hydraulic motors are available, using all manner of construction and materials. These suffer, however, from a number of disadvantages such as being too complicated or difficult to use. Moreover, the turbine system is inefficient. Devices such as those disclosed by certain patents use simple turbine systems, such as U.S. Pat. No. 8,051,527 which discloses a cleaning robot system that can perform wet washing; U.S. Pat. No. 7,631,386 which discloses a hand-held cleaning apparatus for cleaning carpets and other surfaces with a motorized cleaning head: U.S. Pat. No. 302,734 which discloses a self-propelled ground cleaning machine with hydraulically driven rotating brush; U.S. Pat. No. 6,689,078 which discloses a self-contained oral cleaning device in which tap water from the faucet is pressurized to activate variously shaped interchangeable heads with bristles: U.S. Pat. No. 6,213,964 which discloses a hydro-mechanical massaging apparatus with a component that effects massage with water and a turbine, U.S. Pat. No. 4,660,244 which discloses a hydraulic brush for teeth and gums which includes a rotating brush; U.S. Pat. No. 4.441,226 which discloses a car washing apparatus having a rotary brush; and U.S. Pat. No. 4,163,302 which discloses a wall cleaning apparatus with a hydraulically-controlled telescoping boom.

An improved hydraulic motor is needed which operates using low-pressure or high-pressure fluids such as water, and is useful for such applications as cleaning objects and surfaces using water pressure to power a hydraulic brush in a more efficient way.

### SUMMARY OF THE INVENTION

It is therefore an object of the present invention to provide a hydraulic motor capable of using high-pressure or low-pressure fluids such as water, wherein the power of water pressure is applied to effectuate a number of different applications such as rotating a brush using a mechanism that produces alternating flows of water.

It is a further object of the present invention to provide an apparatus wherein water from a conventional faucet or tap is carried through flexible tubing to an hydraulic actuator which alternates the flow of water through the device using a system of valves which open and close, which flow of water causes a brush to rotate.

It is a further object of the present invention to provide an apparatus wherein a supply of water is carried to an hydraulic rotary actuator wherein a system of opening and closing valves causes water flow to alternate between two available paths, causing alternating hydraulic pressure which may be applied for cleaning as well as a variety of other uses.

These and other features of the invention can be further understood by reference to the following drawings.

### BRIEF DESCRIPTION OF THE DRAWINGS

FIG. 1 shows a bottom schematic view of the hydraulic motor according to an embodiment of the present mention that will rotate a brush.

FIG. 2 shows a bottom schematic view of the hydraulic motor according to an embodiment of the present invention that will rotate a brush.

FIG. 3 shows a bottom schematic view of the hydraulic motor according to an embodiment of the present invention that will rotate a brush.

FIG. 4 shows a bottom schematic view of the hydraulic motor according to an embodiment of the present invention that will rotate a brush.

FIG. 5 shows an elevated schematic view of the brush rotated by the hydraulic motor, from the side according to an embodiment of the present invention that will rotate said brush.

FIG. 6 shows an elevated schematic view of the brush rotated by the hydraulic motor, from the other side according to an embodiment of the present invention that will rotate said brush.

FIG. 7 shows an elevated schematic view of the top of the hydraulic motor according to an embodiment of the present invention that will rotate a brush.

FIG. 8 shows an elevated schematic view of the side of a one-way gear box. which may be attached to the hydraulic rotary actuator of the hydraulic motor of the present invention to convert the alternating flow of water, which causes an alternating rotation of a shaft, to a one-way continuous rotation, producing an embodiment of the present invention suitable for many different applications.

FIG. 9 shows an elevated schematic view of the side of the handle and soap dispenser of the hydraulic motor according to an embodiment of the present invention which will rotate a brush.

FIG. 10 shows a bottom schematic view of the hydraulic motor according to an alternate embodiment of the present invention, using a different arrangement of parts to rotate a brush.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

### DETAILED DESCRIPTION OF THE PREFERRED EMBODIMENT

In describing the preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

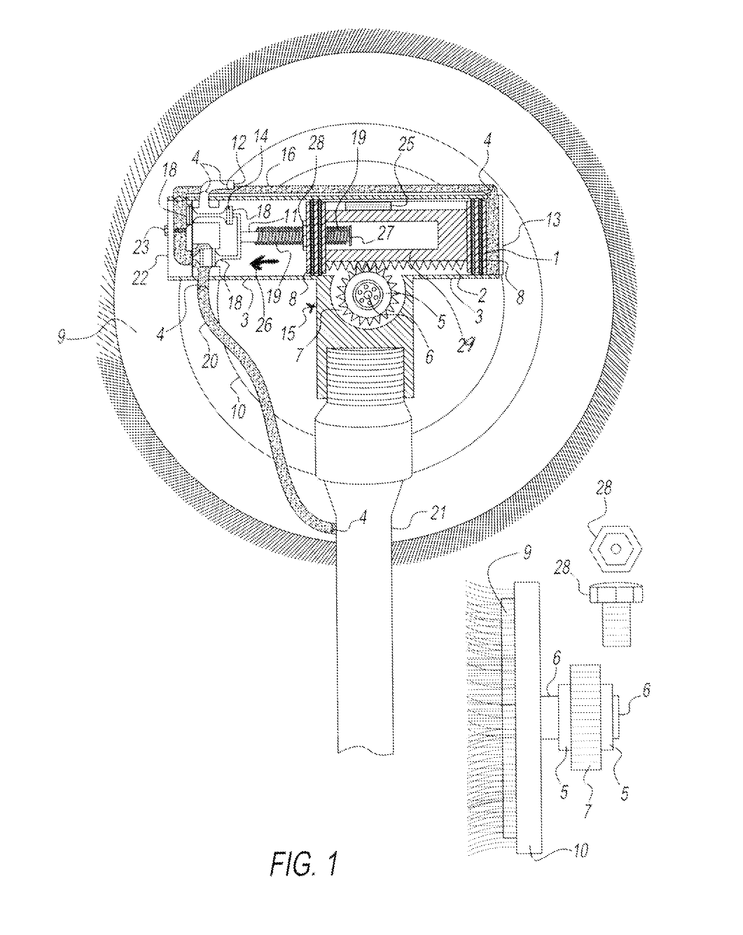

Now referring to the drawings, FIG. 1 shows the hydraulic motor 21 of the present invention. Water under ordinary tap pressure is admitted through a port 4 to entry line 20 and through second port 4 to integrating valve 22. Water is then admitted through valve 18 into a chamber inside cylinder 3. Water then fills the chamber inside cylinder 3, which puts pressure upon and compresses spring 19. The piston 1 is pushed to the right by the pressure of water filling the chamber inside of cylinder 3, teeth inside the gear rack 2 engage with teeth arranged along the outside of gear 7, turning said gear 7. Rotation of gear 7 turns shaft 6 which is removably attached to brush 9, thus rotating brush 9.

Piston 1 moves to the right until the pressure of water is balanced by the tension on the spring 19. At this point Spring 19 pushes the valve trigger 11, which opens valve 22. This causes water to fill the right side of the chamber inside cylinder 3. Water pressure in the chamber inside cylinder 3 pushes piston 1 to the left, putting pressure on spring 19 and causing the engaged teeth of gear 7 to turn in the opposite direction, causing shaft 6 and brush 9 to rotate until the piston 1 reaches the point where water pressure is balanced by the tension put on spring 19. At this point, valve 22 opens and the other valve closes, causing the left side of the chamber inside cylinder 3 to begin filling with water again, starting the sequence over again. This sequence repeats until the user stops the flow of water into the system.

The foregoing figures may be further understood by reference to the following list of parts shown by name and reference number:

| | |
|---|---|
| Piston | 1 |
| Gear Rack | 2 |
| Cylinder | 3 |
| Port | 4 |
| Bearing | 5 |
| Shaft | 6 |
| Gear | 7 |
| Piston Seal | 8 |
| Cover Brush | 9 |
| Brush | 10 |
| Valve Trigger | 11 |
| Valve Exit Line | 12 |
| End Cap | 13 |
| Plug Seals | 14 |
| Hydraulic Rotary Actuator | 15 |
| Water Line to Cylinder | 16 |
| Connector | 17 |
| Valve Plug | 18 |
| Spring | 19 |
| Entry Line to Valve | 20 |
| Extension Pipe | 21 |
| Integrating Valve | 22 |
| Valve Connection Screw | 23 |
| Soap Dispenser | 24 |
| Support for Piston | 25 |
| Direction of Piston | 26 |
| Retaining Screw for Spring | 27 |
| Bolt with hole in center to | 28 |
| accommodate piston trigger | |
| Hollow chamber for | 29 |
| Valve trigger | |

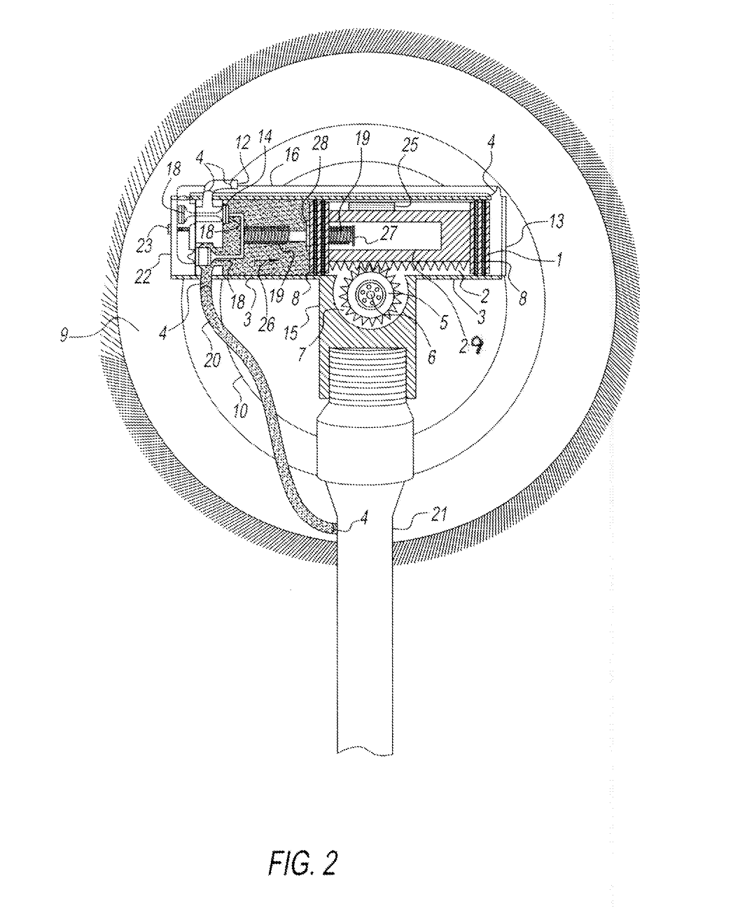

FIG. 2 shows the further progression of fluid through the hydraulic motor, causing movement of fluid filling the left chamber of cylinder 3, pushing the piston 1 in the direction shown by the arrow 26, to the right.

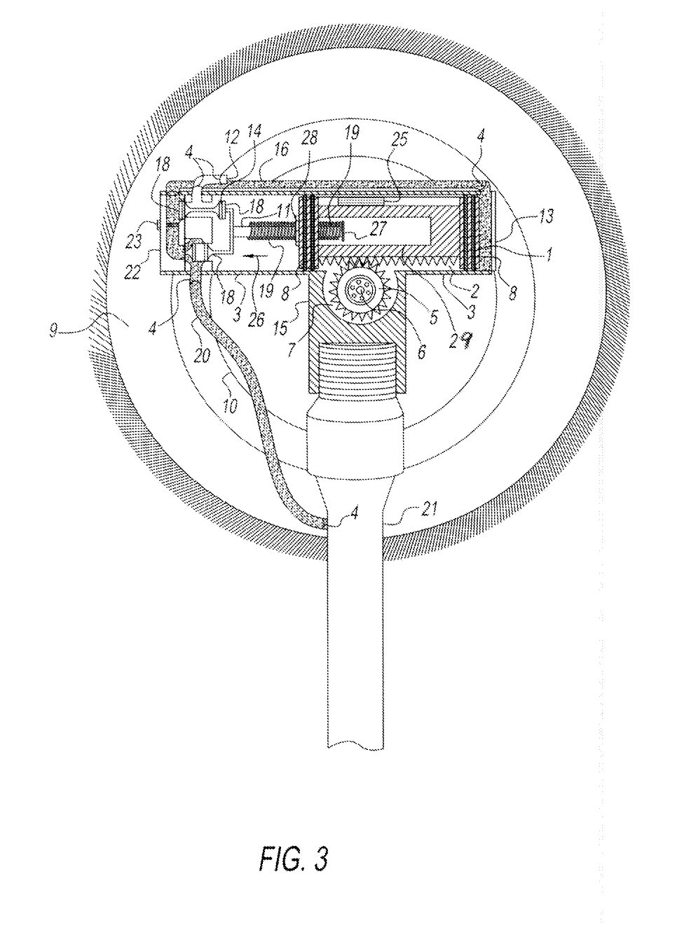

FIG. 3 shows the further progression of fluid through the hydraulic motor, filling the right side of the chamber of cylinder 3, pushing piston 1 in the direction shown by the arrow 26, to the left.

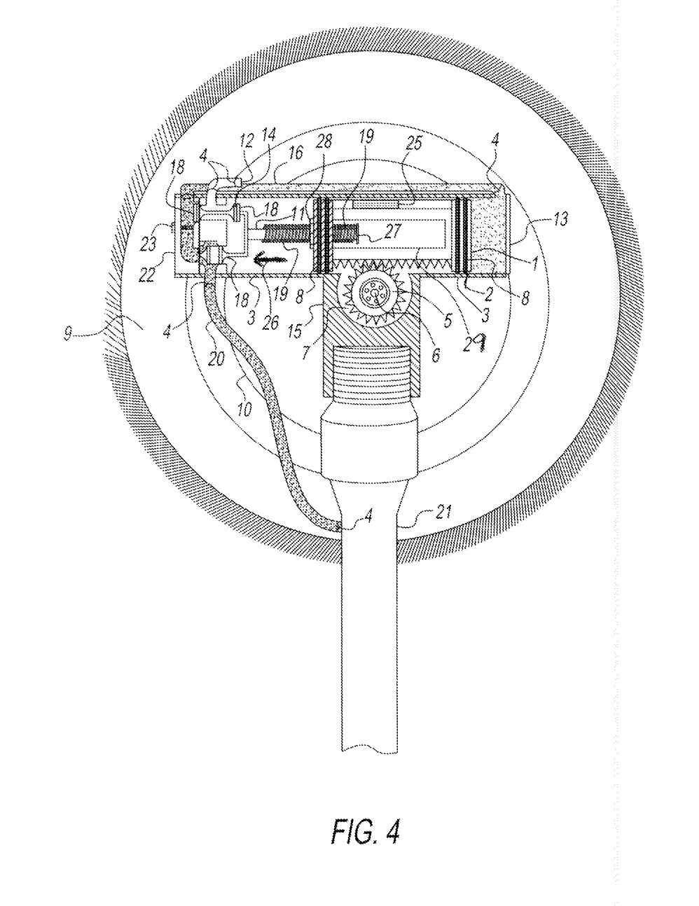

FIG. 4 shows the further progression of fluid through the hydraulic motor, further filling the right side of the chamber of cylinder 3, pushing piston 1 in the direction shown by the arrow 26, to the left.

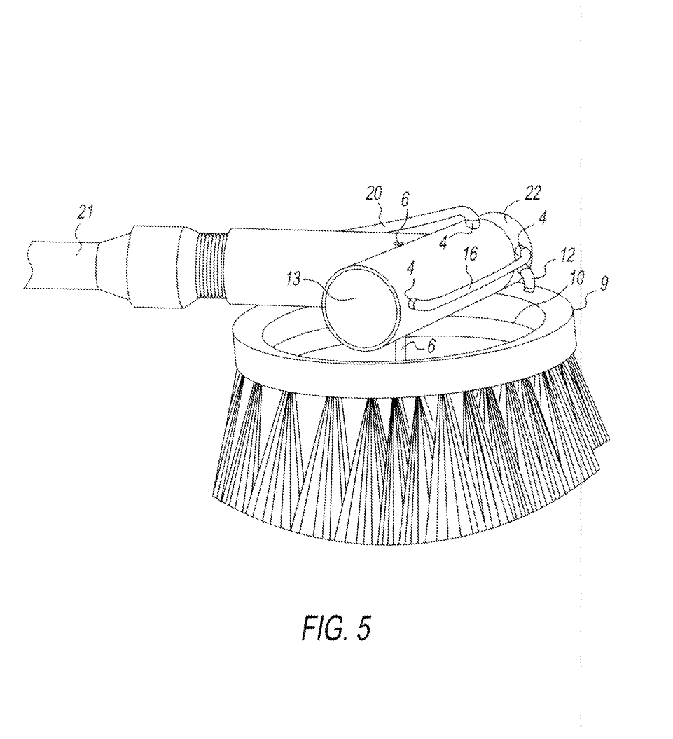

FIG. 5 shows the exterior parts of the hydraulic motor, illustrating the port 4, the shaft 6, the cover brush 9, the brush 10, the valve exit line 12, the end cap 13, the water line to the cylinder 16, the entry line to valve 20, the extension pipe 21 and the integrating valve 22.

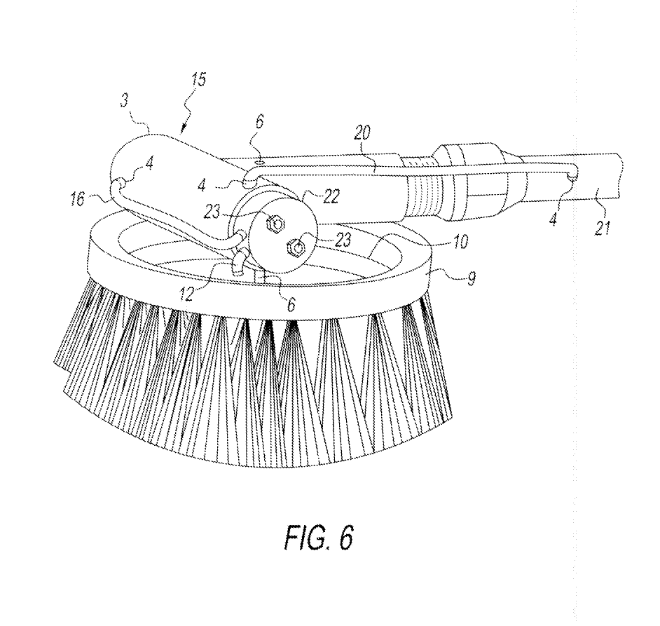

FIG. 6 shows the exterior parts of the hydraulic motor from the other side illustrating the cylinder 3, the port 4, the shaft 6, the cover brush 9, the brush 10, the valve exit line 12. the hydraulic rotary actuator 15, the water line to the cylinder 16, the entry line to valve 20, the extension pipe 21, the integrating valve 22 and the valve connection screws 23.

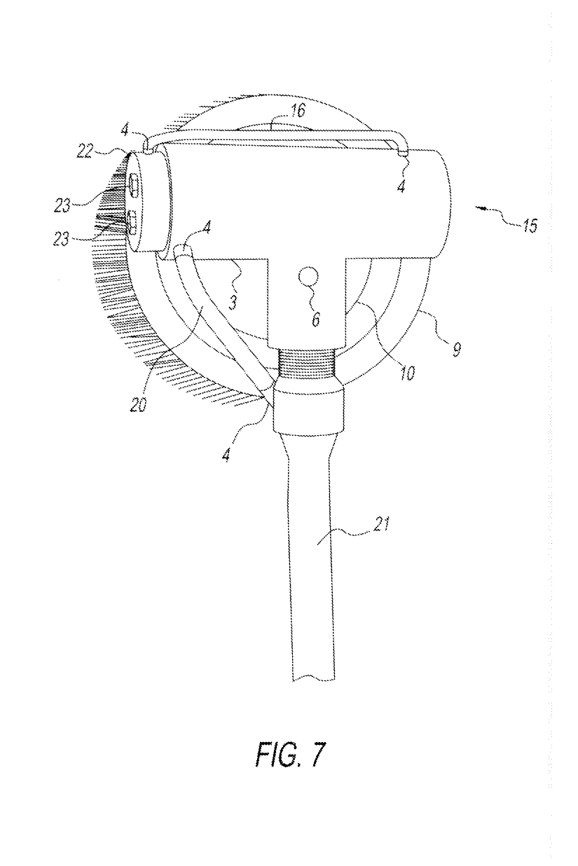

FIG. 7 shows the exterior parts of the hydraulic motor from the top, illustrating the cylinder 3, the port 4, the shaft 6, the cover brush 9, the brush 10, the hydraulic rotary actuator 15, the water line to the cylinder 16, the entry line to valve 20, the extension pipe 21, the integrating valve 22 and the valve connection screws 23.

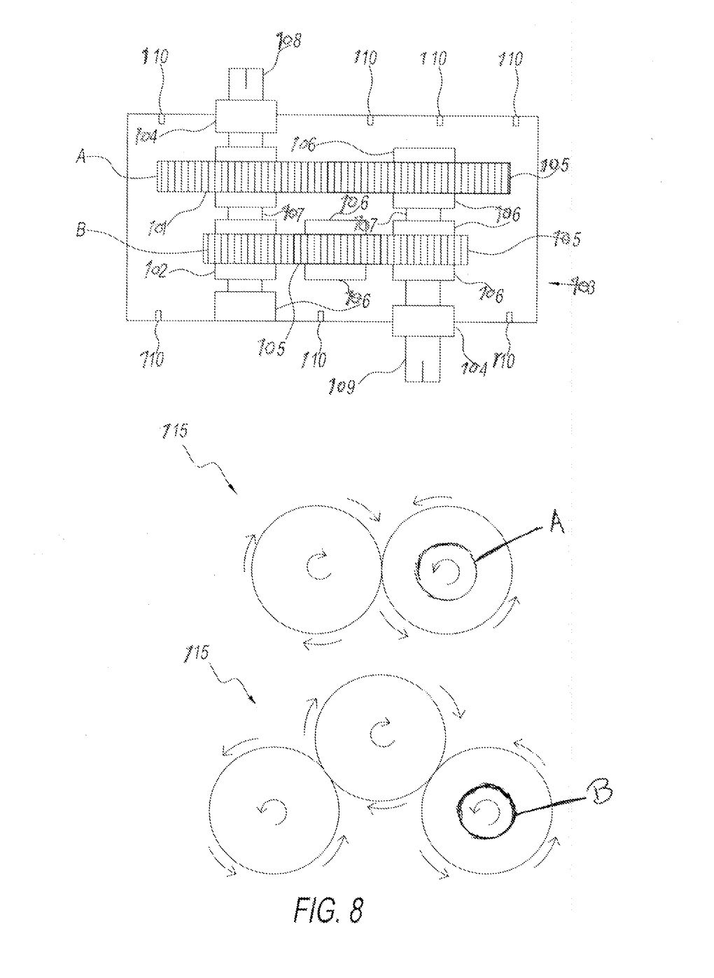

FIG. 8 shows a one-way gearbox, which may be attached to the hydraulic motor of the present invention to the shaft 1 shown in FIG. 1. The one-way gearbox will allow the shaft to rotate in only one direction, enabling the present invention to be applied to a wide variety of applications. A one-way gear or gear clutch 101 is mounted on the shaft, and will clutch when motion goes to the right. A second one-way gear or gear clutch 102 is mounted on the shaft and will clutch when motion goes to the left. The body 103 of the one-way gearbox contains the gears, the shaft and the bearings. The bearing 104 will reduce friction and prevent oil from leaking from the one-way gearbox. The gear 105 is attached to the shaft. The bearing 106 is mounted on the shaft to reduce friction. The gear 105 and the hearing 106 are mounted on the shaft 107. A shaft 108 connects to the hydraulic rotary actuator 15 shown in FIG. 1. A shaft 109 connects to a variety of other embodiments including a gearbox speed increaser, generator, washing machine or a variety of other applications. The body of the gear box 103 is attached to the hydraulic rotary actuator 15 shown in FIG. 1 at seven connection points 110.

The action of the one-way gear box is described in FIG. 8 by the clutch A which controls two gears, and will allow the first gear 107 and second gear 106 to rotate to the right or to the left, but will clutch when it goes right, releasing the shaft. Clutch B controls three gears; the first gear 102 may rotate to the left or to the right, the second gear 105 may rotate to the left or to the right and the third gear 106 may rotate to the left or to the right, but will clutch when it goes to the left, releasing the shaft.

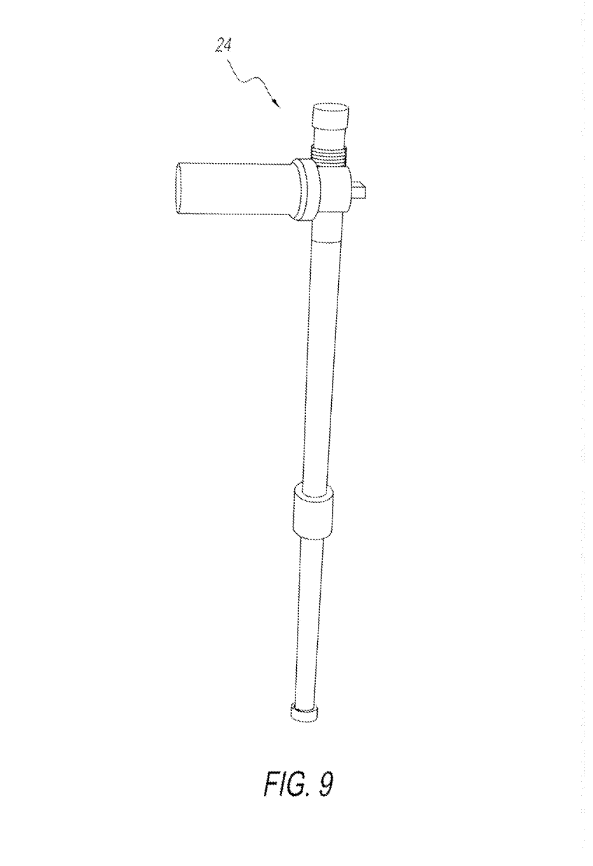

FIG. 9 shows the extension pipe 21.

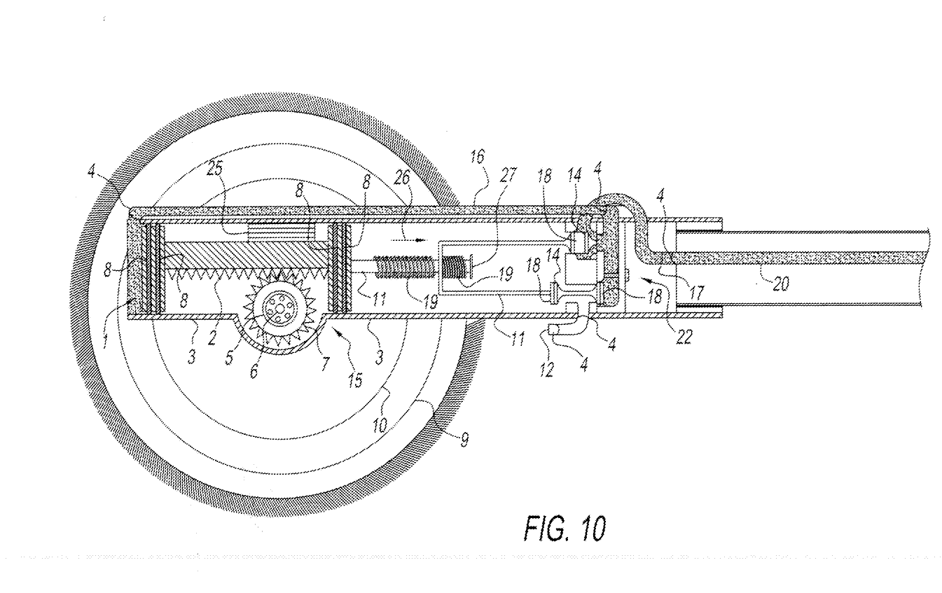

FIG. 10 shows the progression of fluid through another embodiment of the hydraulic motor using the same parts in a slightly different arrangement, with the fluid filling the entry line to valve 20, the water line to cylinder 16, through port 4, causing movement of fluid filling the left chamber of cylinder 3, pushing the piston 1 in the direction shown by the arrow 26, to the right.

What is claimed is:

1. A hydraulic motor able to use low-pressure or high-pressure fluids such as water for a large variety of applications, comprising:
a body having a left side and a right side defining a horizontal axis for said body and a front end and a rear end defining a longitudinal axis for said body, perpendicular to said horizontal axis, said body containing a cylinder capable of holding a fluid such as water, said fluid being transported through a fluid transport line, from a source to the interior of a rotary actuator cylinder, through a five way double pilot valve, said fluid exerting pressure on a piston which moves to the side, rotating a shaft capable of rotating a brush or similar attachment, exerting pressure on a spring until the piston can no longer move, when the settings of the valves reverse, admitting fluid into the other side of said rotary actuator cylinder, exerting pressure on said piston, moving it in the opposite direction and rotating said brush or similar attachment in the opposite direction.

2. The hydraulic motor of claim 1, wherein the fluid supplied is high-pressure water.

3. The hydraulic motor of claim 1, wherein the fluid supplied is low-pressure water.

4. The hydraulic motor of claim 1, wherein said rotary actuator cylinder is attached to a one-way gear box, converting the alternating rotation of said brush or similar attachment to one-way continuous rotation.

5. The hydraulic motor of claim 1, wherein the rotating brush or similar attachment allows said hydraulic motor to power an electrical generator.

6. The hydraulic motor of claim 1, wherein the rotating brush or similar attachment allows said hydraulic motor to power a washing machine.
